(19) United States
(12) Patent Application Publication
(10) Pub. No.: US 2005/0218590 A1
(43) Pub. Date: Oct. 6, 2005

(54) Communal gaming wager feature

(75) Inventors: Terry O'Halloran, Bellevue Hill (AU); Scott Clarebrough, Hunters Hill (AU)

Correspondence Address: SACCO & ASSOCIATES, PA, P.O. BOX 30999, PALM BEACH GARDENS, FL, 33420-0999, US

(73) Assignee: Stargames Corporation Pty Limited, Milperra (AU)

(21) Appl. No.: 11/089,705

(22) Filed: Mar. 25, 2005

(30) Foreign Application Priority Data
Mar. 25, 2004 (AU) 2004901618

(51) Int. Cl. A63F 1/00; A63F 13/00; A63F 1/18

(52) U.S. Cl. 273/138.1; 273/143 R; 273/139; 463/20

(57) ABSTRACT

A gaming method and system for use in a communal gaming arrangement. In the event that a player wins the primary game, each winning player is given the opportunity to play a different second communal game with their winnings from the primary game.

### CROSS REFERENCE TO RELATED APPLICATIONS

This application claims the priority of Australian patent application number 2004901618 filed on Mar. 25, 2004.

### TECHNICAL FIELD

This invention relates to special wagering features in a communal game.

### BACKGROUND ART

The present invention is concerned with gaming machines, including simulated reel games, simulated casino games and the like. Gaming machines in their current format are often designed with features to reward players with higher value wins. The trade off for this is that these winning features are often harbouring a large amount of the gaming machine's Return to Player (RTP), and that in order to provide larger wins, the RTP accumulates on average for a relatively long period. In most instances, the feature is awarded to players after a pre-determined symbol combination has been achieved, and the feature provides bonus wins over and above the standard game. These are seen as desirable by many players, as the players can win large value prizes in a shortened period.

On a communal gaming machine, all players place bets on individual terminals, but all are betting against a common, centrally determined outcome. A traditional implementation of this type of game is a fully automated simulated roulette game. The present applicant proposes to operate simulated reel or slot machines on a communal basis. It is not easy to implement effective jackpot systems in a communal gaming environment, as all players are playing using the same game outcomes and hence new forms to create an attraction to players must be found.

It is an object of the present invention to provide a feature for communal games which will add to the entertainment of players, and provide a focus for communal play.

### SUMMARY OF THE INVENTION

In a broad form, the present invention provides an additional feature for a communal game. After a particular outcome, for example a specific symbol combination, the player is awarded a prize, and has an option to participate in an additional game. The additional game may preferably only be played with the winnings from the specific symbol combination. The additional game is also communal in outcome, although preferably players may wager on different outcomes using a variety of wager options.

According to one aspect, the present invention provides a method of operating a communal game, said game including a plurality of betting terminals, and having a centrally determined game outcome, each terminal accepting wagers from a respective player, the method including the steps of:
(a) determining the wagers made at each terminal on a primary game;
(b) playing the game and determining an outcome;
(c) if the outcome corresponds to one or more predetermined selected winning outcomes, then providing a corresponding credit to each winning player, and providing an option to play a second, different communal game; and
(d) playing said second game.

The second game is preferably of an entirely different nature, for example a horse race following a simulated moving reels game. It is preferred that the only credits permitted for the second game are those won on the first outcome. Preferably the RTP on the second game is higher than on the first game, and most preferably the RTP is equivalent to, or better than, the option of retaining the original credit.

According to another aspect, the present invention provides a communal gaming machine system, including a plurality of betting terminals, and a central game outcome determining means communicating with each said terminal to determine a communal game outcome, each terminal accepting wagers from a respective player, the wagers relating to said centrally determined game outcome, wherein operatively if the communal game outcome of a primary game corresponds to one or more predetermined selected winning outcomes, then each player who had wagered on the predetermined selected winning outcome which is the game outcome is provided with an option to play a second, different communal game.

The present invention provides an interesting second game only accessible if the player participates in the primary game when the appropriate outcome—for example, a specific combination or set of combinations—is achieved. It functions to provide an additional entertainment for the players communally, and to provide an incentive to participate in the primary game.

### BRIEF DESCRIPTION OF THE DRAWINGS

The present invention will be described with reference to the accompanying figures, in which:

FIG. 1 is a schematic illustration of a communal gaming system.

FIG. 2 is a flowchart illustrating one implementation of the inventive method.

FIG. 3 is a sample screen display for one implementation of the primary game.

FIG. 4 is a sample screen display for one implementation of the secondary game.

FIG. 5 is a sample screen display for another implementation of the secondary game.

### DETAILED DESCRIPTION

The invention will be described with reference to a specific embodiment. However, it will be appreciated that the present invention may be implemented in many different types of communal games, in combination with many secondary features 5, as would be apparent to those skilled in the art. It will also be appreciated that apart from varying payouts to accommodate the portion of each wager attributable to the secondary game 5, the ordinary operation of the main game 1 is not required to be modified. Hence, the present invention could be implemented as an additional feature on any communal game. For example, although the following description is predominantly in the context of the primary game 1 being a simulated reels type slot game, the primary game 1 could be a table game such as roulette, a card game, or any other suitable game.

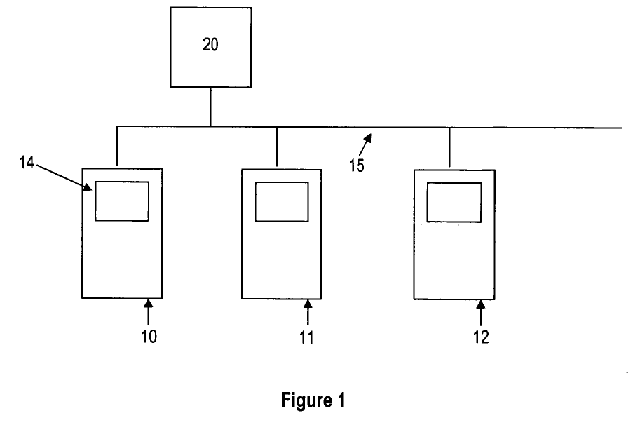

FIG. 1 shows one general arrangement of a communal gaming system. Central controller 20 is linked via network 15 to a plurality of individual gaming machines 10, 11, 12. Each gaming machine includes normal features of a gaming machine, such as a display 14, and other usual features (not shown) such as buttons to control wagers, selection of play features, and the like. The precise configuration of the machine is not essential to the present invention. The communal gaming system differs from conventional stand alone machines in that each machine is not actually operating the game as such. The local machine is only required to accept wagers and the like, and display bets and results to the player. The symbols for display, and game results, are generated by the central controller 20, which may be considered in this illustrative form as including a game outcome generator, for determining the outcome of games, communal displays, etc, and a secondary game 5 controller for carrying out the secondary game 5 functions. In some implementations, one of the gaming machines 10, 11, 12 may function as the game outcome generator, and communicate game outcomes to the other gaming machines. However, it is preferred that the secondary game 5 functions are carried out by a separate secondary game 5 controller, as it the case for conventional game systems.

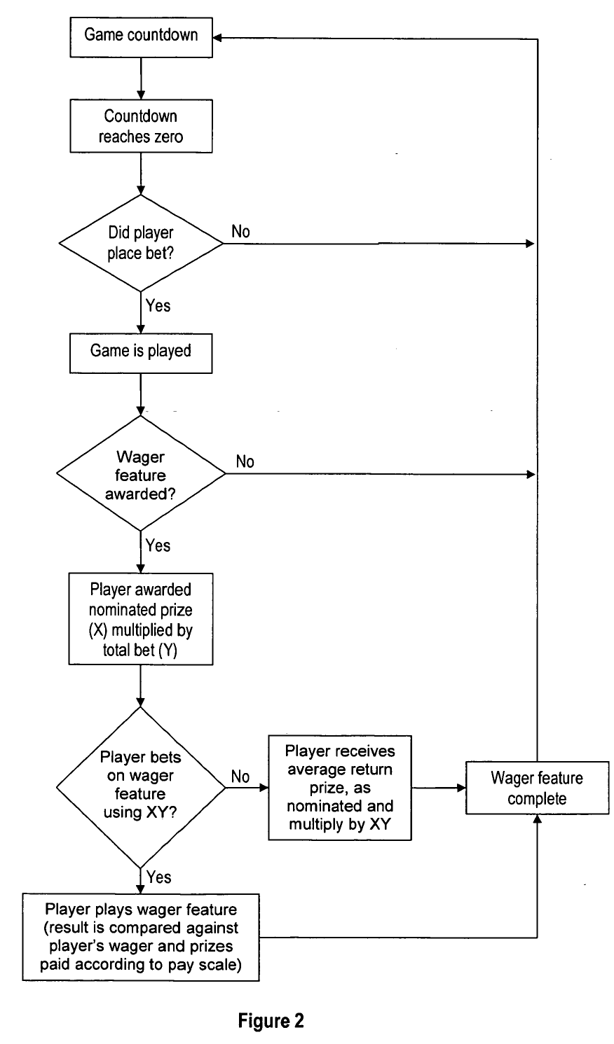

In the preferred implementation, as illustrated in FIG. 2 and which will be described further below, the game is divided into a primary game 1 and a wager feature bonus 5 (secondary game), and the player makes decisions about what to do with the credit 3 won from the primary game 1. It is preferably only certain winning outcomes 2 which allow possible entry to the secondary game 5. The player may wager on the secondary game 5 in a number of ways that produce a variety of different possible return options. The RTP on each bet will be equal, taking account of the odds and the various options provided to the player. The limitation 5 is that the players may only use credits 3 they have won via the specified combination in the primary game 1 in the secondary game 5.

It is preferred that the secondary game 5 return is already calculated in the total RTP by virtue of probability so as to not have any influence over the primary game 1 irrespective of what the player does in the bonus feature 5. Understandably, there may be short term implications as players beat the odds and win, or lose more than they should, but over time, it will be appreciated that the statistical return is preferably near consistent. It will be also be appreciated, however, that given the occurrence of the bonus wager game 5 is preferably random, occurring for example on average every 100 games, there exists the possibility of a longer sequence time spent in the main game 1. It is to be understood that the effect of this would be that the return a player experiences over such a sequence will be on average lower than that experienced where the bonus wager game 5 is triggered more often over a given time frame.

It will be understood that the type of bets placed in the bonus wager game 5 will ultimately effect the variance of wins across the entire game. In the bonus feature game 5, if the player chooses to bet on outcomes with a higher probability of success (but with a lower return) then the variance of the entire game will be less than for a player who chooses to bet on outcomes with a smaller likelihood of success (but with higher return).

The following example is provided to assist in an understanding of the invention.

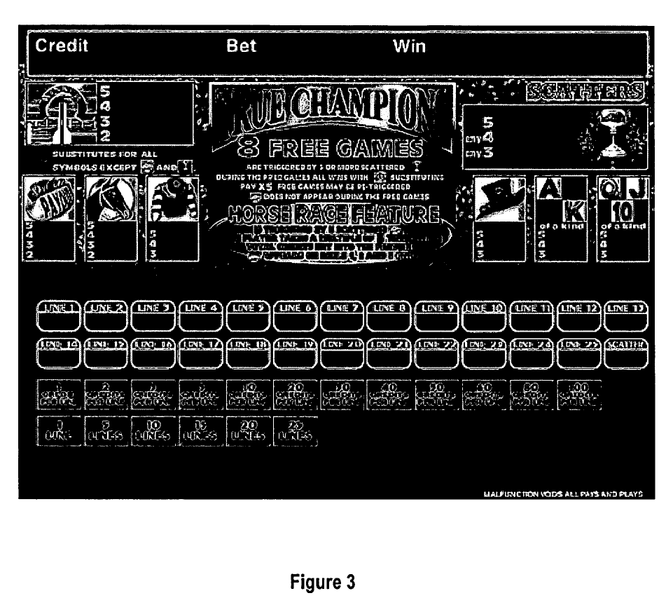

FIG. 3 is an example of a primary game 1 screen in which a player wagers $1 for every game played prior to a countdown 6 expiring 7. As the player's bet increase, the prize values will be accordingly updated. In the instance that in a particular game on which the player has wagered 8, a designated number of symbols appear in a pre-determined pattern, the player will be awarded a prize of X 3. A player who makes a larger or smaller bet may win multiples of X 3. The player will have the option of taking the value of X (or a multiple of X, depending on how the game is designed) as a credit and taking no more part in the game 9, or electing to use the wins to wager 4 on a secondary game 5 that will be presented to the player. It is preferred that the players will be eligible to bet the provided value on a single outcome, or a range of combined outcomes. It is further preferred that the reward for each option is related to its chance of occurrence and that the probabilities are constructed such that the RTP for each wager is the same, to a reasonable degree of accuracy.

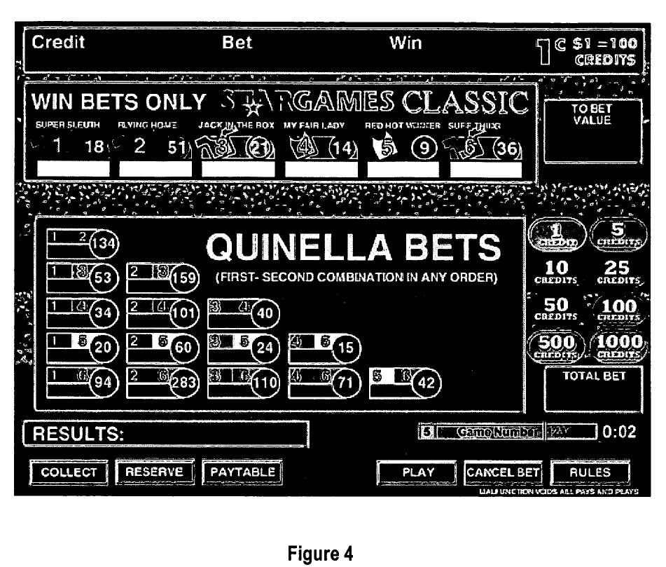

FIG. 4 is an example of a secondary game 5 screen, which in this implementation, is based on a horse race with at least 2 horses taking place. This is of course only one embodiment. Alternatives include any other sort of race or outcome determined event. The players could participate in a simulated casino game, a card game, or any other suitable game. It will be understood that the secondary game 5 could be one which is more time consuming and hence may be less desirable as a primary game 1 for the gaming operator, but which is acceptable as an occasional point of interest for the players. There may be multiple possible secondary games 5, either arising at random or in sequence or otherwise as desired.

For this example, the horse race will include a number of runners that are assigned odds based on their chance of winning. Players may bet on the horse to win, run a place or multi-result bets that group horses such as quinellas (i.e. first 2 horses in any order) and trifectas (first 3 horses in order). The player may wager as much of the credits available as they like, being the credits from the specific win on the primary game 1, with the remainder of such credits being included as part of the original win, which is retained regardless of the outcome of the race. The game may only allow some proportion of the specific credits to be wagered, with the remainder being retained as part of the player's general game credits.

For example, the prize, probability of winning and RTP for a bet that a horse will win is shown by the table below.

| | | | Return To |
|---|---|---|---|
| Horse Number | PRIZE | Probability | Player |
| 1 | 12 | 0.2501 | 300.16% |
| 2 | 13 | 0.2309 | 300.16% |
| 3 | 15 | 0.2001 | 300.16% |
| 4 | 17 | 0.1766 | 300.16% |
| 5 | 31 | 0.0968 | 300.16% |
| 6 | 66 | 0.0455 | 300.16% |

In this example, we assume that a player wagering 10 units on horse number 4 will win 170 units 17.66% of the time. The RTP for this wager is calculated as 17 (the prize) multiplied by 0.1766 (the probability), equalling 300.16%.

In another example, the prize, probability of winning and RTP for a quinella bet is shown by the table below.

| Horse | | | |
|---|---|---|---|
| Combination | | | Return To |
| (any order) | PRIZE | Probability | Player |
| 1-2 | 20 | 0.1501 | 300.16% |
| 1-3 | 23 | 0.1305 | 300.16% |
| 1-4 | 27 | 0.1112 | 300.16% |
| 1-5 | 51 | 0.0589 | 300.16% |
| 1-6 | 110 | 0.0273 | 300.16% |
| 2-3 | 25 | 0.1201 | 300.16% |
| 2-4 | 29 | 0.1035 | 300.16% |
| 2-5 | 56 | 0.0536 | 300.16% |
| 2-6 | 120 | 0.0250 | 300.16% |
| 3-4 | 35 | 0.0858 | 300.16% |
| 3-5 | 66 | 0.0455 | 300.16% |
| 3-6 | 142 | 0.0211 | 300.16% |
| 4-5 | 76 | 0.0395 | 300.16% |
| 4-6 | 162 | 0.0185 | 300.16% |
| 5-6 | 315 | 0.0095 | 300.16% |

In this example, we assume that a player wagering 10 units on the quinella combination 2-4 will win 290 units 10.35% of the time. It will be appreciated that a successful result will be when horse 2 finishes first and horse 4 finishes second or when horse 4 finishes first and horse 2 finishes second. The RTP for this wager is calculated as 29 (the prize) multiplied by 0.1035 (the probability), equalling 300.16%.

It will be appreciated that as quinella results are not independent of the win results and the probabilities of each quinella are preferably derived in part from the probabilities of the different win outcomes.

It will be understood that the present invention may be implemented with a wide variety of types of secondary games 5. The horse racing example is only a specific alternative.

Once the bets have been placed in the allotted time, the result is determined by the gaming device and presented via a graphic representation or the like. In a preferred implementation, this may be an appealing animated horse race, with appropriate commentary. The player's wagers will be evaluated for any win 5 after the race is concluded, and paid accordingly. Upon completion of the race 9, the game will revert back to the primary mode of game play 6.

It will be understood that this race would take place on the shared display, and be a focal point for the players. The RTP on the secondary game 5 is high, and as a result players are eager to play the primary game 1 in the hope that this secondary game 5 will be triggered.

An important component of the preferred implementation is awarding players a prize that they may keep, or elect to use that prize to wager 4 on a result that can increase that prize. The wager options would be commensurate with the risk involved of winning that prize, and the player can elect to wager on a number of outcomes to ‘hedge’ their bet or bet only a portion of the win. To make the feature attractive, the players will be offered odds in excess of the chance of winning. This is the preferred embodiment, but other options may be employed.

FIG. 5 is an example of the betting screen where the ‘Win’ value is the amount the player was awarded 3 after a designated pattern of symbols appeared in the main game, and the ‘Take Win’ value is the amount the player may take instead of betting on the variable odds feature. The ‘Wager’ value is what the player may use to bet on options. A mechanism will be available for players to touch their bet option on a separate tile that shows the return on the outcome of, in this case, the horse race. This is incremented by a value selected by the player. As the player selects options, the ‘Take Win’ value will reduce correspondingly to the amount used from the ‘Wager’ amount. In the example provided, the odds offered to the player are over the odds based on the number of horses racing, so the offer made to them to ‘Take Win’ is again proportionate to what the return in the horse race may be.

It is highly preferred that the returns on the bet options provided are the same overall return as the ‘Take Win’ option the player is offered. This is to ensure player fairness regardless of the player's decision.

In another preferred embodiment, the wager feature is implemented using a designated character, for example a monkey, in a series of events where players wager on the outcome. Some example scenarios are discussed below.

In the first scenario, the monkey is behind a powerboat and about to be pulled over a jump. The players wager how far the monkey will get with corresponding odds attached to this. To make this wager attractive to the player, it is preferred that all odds are increased by 3 times. The odds are in reverse proportion to the monkey making that distance as shown by the table below.

| | Return on 1 credit |
|---|---|
| Distance | wager |
| 0 m to 5 m | 18:1 |
| 6 m to 10 m | 10:1 |
| 11 m to 15 m | 5:1 |
| 16 m to 20 m | 8:1 |
| 21 m to 25 m | 11:1 |

By making the odds greater than they normally would be, the wager feature is using this to reward players and allowing them to bet a certain amount with a larger return. Preferably, this is included in the total RTP of the game.

In the second scenario, the monkey has a coconut tree to climb in order to get a bag of money at the top. Markers can be placed along the length of the coconut tree to indicate how far the monkey will get up. The player wagers how far the monkey will get up, for example 1 m, 2 m, 3 m, 4 m or 5 m. It is preferred that if the monkey gets to the top, all players will earn a bonus, even though they did not and can not directly bet on that particular outcome.

In another example, the wager feature provides a betting period in which players can place an ante bet for when a certain event will occur. For example, the ante bet may be placed for 100 credits in the eventuation a result of 3 scattered ‘X’s occur. It will be appreciated that regardless of whether the combination pays a feature or not, the players are merely playing a side bet on another event that offers a prize. This may be implemented by providing odds that the event happens in that particular game, or that the event happens in a range of games. For example, a 20 game cycle may be selected by the player. At the beginning of the cycle, players have the opportunity to bet on a nominated event, which may be a single event out of numerous events, each with different odds. Once the bets have been made, if the eventuation of this event occurs within the preselected time period, the player will be awarded a prize. Upon eventuation of the event, the cycle may either be reset, or the player may continue to play until the end of the preselected period in the hope that the players may win multiple times.

The present invention may be implemented at a single site, or across many sites linked by suitable communications and control systems, such as are well known for conventional linked gaming systems.

It will be appreciated that the present invention is of broad application, and can be implemented in a variety of ways. Variations and additions are possible within the general scope of the present invention.

1. A method of operating a communal game, said game including a plurality of betting terminals, and having a centrally determined game outcome, each terminal accepting wagers from a respective player, the method including the steps of:
a) determining the wagers made at each terminal on a primary game;
b) playing the game and determining an outcome;
c) if the outcome corresponds to one or more predetermined selected winning outcomes, then providing a corresponding credit to each winning player, and providing an option to play a second, different communal game; and
d) playing said second game.

2. A method according to claim 1, wherein step c) allows each player to wager on the second game using only credits won on said one or more predetermined selected winning outcomes.

3. A method according to claim 1, wherein the return to player for the second game is equal to or higher than for the primary game.

4. A method according to claim 3, wherein the return to player for the second game is greater than 100%.

5. A method according to claim 2, wherein the second game is of a different nature to the primary game.

6. A method according to claim 5, wherein the primary game is a simulated reels game, and the secondary game is a racing game.

7. A method according to claim 2, wherein the player may select different outcomes for wagers in the second game.

8. A method according to claim 4, wherein if in step (c) a player elects not to play the second game, then the player is awarded their corresponding credit according to the primary game, multiplied by the average return to player for the second game.

9. A communal gaming machine system, including a plurality of betting terminals, and a central game outcome determining means communicating with each said terminal to determine a communal game outcome, each terminal accepting wagers from a respective player, the wagers relating to said centrally determined game outcome, wherein operatively if the communal game outcome of a primary game corresponds to one or more predetermined selected winning outcomes, then each player who had wagered on the predetermined selected winning outcome which is the game outcome is provided with an option to play a second, different communal game.

10. A gaming machine system according to claim 9, wherein each player is only permitted to wager on the second game using credits won on said one or more predetermined selected winning outcomes.

11. A gaming machine system according to claim 9, wherein the return to player for the second game is equal to or higher than for the primary game.

12. A gaming machine system according to claim 11, wherein the return to player for the second game is greater than 100%.

13. A gaming machine system according to claim 12, wherein if a player elects not to play the second game, then the player is awarded their corresponding credit according to the primary game, multiplied by the average return to player for the second game.

14. A gaming machine system according to claim 10, wherein the second game is of a different nature to the primary game.

15. A gaming machine system according to claim 14, wherein the primary game is a simulated reels game, and the second game is a racing game.

16. A gaming machine system according to claim 9, wherein the player may select different outcomes for wagers in the second game.

17. A software product operatively adapted to carry out the method according to claim 1.
